(19) United States
(12) Patent Application Publication
(10) Pub. No.: US 2012/0224973 A1
(43) Pub. Date: Sep. 6, 2012

(54) BLADE FOR A WIND TURBINE

(76) Inventor: Azad Hessamodini, Shenton Park (AU)

(21) Appl. No.: 13/390,904

(22) PCT Filed: Aug. 20, 2010
(86) PCT No.: PCT/AU2010/001078

§ 371 Date: May 3, 2012

(30) Foreign Application Priority Data
Aug. 20, 2009 (AU) 2009903949

(51) Int. Cl. F03D 3/06

(52) U.S. Cl. 416/229 R

(57) ABSTRACT

The present disclosure provides a wind turbine. The wind turbine has an axis about which in use the blade rotates. The blade is arranged for orientation along the axis and has a longitudinal twist. The blade comprises an inner blade portion and an outer blade portion. The inner blade portion is in use closer to the axis than the outer blade portion. The outer blade portion has an angular orientation that varies relative to the inner blade portion in a direction along the axis.

### FIELD OF THE INVENTION

The present invention relates to a blade for a wind turbine. Particularly, although not exclusively, the present invention relates to a blade for a vertical axis wind turbine.

### BACKGROUND

Vertical axis wind turbines, which have a rotatable blade assembly arranged in a substantially vertical direction, are not dependent on wind direction like their horizontal axis wind turbine counterparts. Vertical axis wind turbines come in a variety of forms, including Darrieus or so called ‘eggbeater’ wind turbines and Savonius wind turbines. Another type of vertical axis wind turbine is described in WO 03/058061 entitled “A Vertical Axis Turbine”.

There is now great interest in using vertical axis wind turbines to harness renewable energy. As such, this area of technology is in constant development and there is a need for improvement.

### SUMMARY OF THE INVENTION

In accordance with a first aspect of the present invention there is provided a blade for a wind turbine, the wind turbine having an axis about which in use the blade rotates, the blade being arranged for orientation along the axis and having a longitudinal twist, the blade comprising an inner blade portion and an outer blade portion, the inner blade portion being in use closer to the axis than the outer blade portion, the outer blade portion having an angular orientation that varies relative to at least a region of the inner blade portion in a direction along the axis.

In one specific example at least a region of the inner blade portion, or even the entire inner blade portion, is less twisted than the outer blade portion.

Alternatively, at least a region of the inner blade portion, or even the entire inner blade portion, may be more twisted than the outer blade portion.

In one embodiment the inner and typically also the outer blade portions have surfaces that have a substantially linear cross-sectional shape in a plane perpendicular to a direction of elongation of the blade.

The outer blade portion typically forms an obtuse angle with at least a portion of the inner blade portion. The angular orientation of the outer blade portion relative to the inner blade portion may vary from 180 or almost 180 degrees to a smaller obtuse angle along the length of the blade and near an area of contact between the inner blade portion and the outer blade portion.

The rate of change of the angular orientation of the outer blade portion relative to at least a portion of the inner blade portion may be linear along the length of the blade, although it is envisaged that the rate of change of the angular orientation may at least partially vary in a non-linear manner.

The longitudinal twist may be such that the blade has a substantially helical configuration. An axis of the longitudinal twist may be outside the blade. In one embodiment, the axis of the longitudinal twist coincides with the axis of rotation.

In one specific embodiment, at least a substantial portion of the blade, such as the inner blade portion, is twisted through an angle of substantially 120° along the length of the blade. The blade in accordance with this embodiment may for example be used in a blade assembly having 3 blades. In variations of this embodiment the inner blade portion may be twisted by less than 120°. For smooth operation and a substantially uniform torque output of a wind turbine it is advantageous if the combined total longitudinal twist is of the order of 360° or more. However, if at least a region of the outer blade portion is twisted by a twist angle that is larger than that of at least a region of the inner blade portion, smooth operation of the wind turbine and generation of a relatively uniform torque output is facilitated also for blade assemblies in which the combined twist of the inner blade portions is smaller than 360°.

In other specific examples the blade may be twisted by an angle of 90° or less (for example for a blade assembly comprising 4 blades) or may be twisted by an angle of 180° or less (for example for a blade assembly comprising 2 blades).

The inner blade portion may comprise first and second inner blade portions and the blade may be arranged such that the second inner blade portion is positioned between the first inner blade portion and the outer blade portion. In one embodiment, the second inner blade portion typically forms an obtuse angle with both the first inner blade portion and also the outer blade portion. The first inner blade portion and the second inner blade portion may have an angular orientation relative to each other that is substantially constant along the length of the blade. Alternatively, the first inner blade portion and the second blade portion may have an angular orientation relative to each other that changes along the length of the blade.

The blade typically is a substantially rectangular element that is twisted.

The blade may have any suitable length, for example 3-5 m, 5-10 m or even longer. Further, the blade may have any suitable width, such as 1-1.5 m, or 1.5 to 3 m or more.

The length to width aspect ratio may for example be of the order of 1:1-3:1, or 1.5:1-2.5:1 or 1.6:1-2.2:1. In one specific example the aspect ratio is 1.61:1.

In accordance with a second aspect of the present invention there is provided a blade assembly for a vertical axis wind turbine, the blade assembly comprising a plurality of the above-described blades.

The blade assembly may comprise 3 blades and may be arranged at substantially 120° around the axis of rotation.

In accordance with a third aspect there is provided a vertical axis wind turbine comprising the blade assembly in accordance with the second aspect of the present invention.

The invention will be more fully understood from the following description of specific embodiments of the invention. The description is provided with reference to the accompanying drawings.

### BRIEF DESCRIPTION OF THE DRAWINGS

FIG. 1 shows a perspective view of a blade for a wind turbine in accordance with an embodiment of the present invention;

FIG. 2a shows a cross-sectional view of a lower section of the blade of FIG. 1;

FIG. 2b shows a cross sectional view of an upper section of the blade of FIG. 1;

FIG. 3 shows a series of cross-sectional views of the blade of FIG. 1; and

FIG. 4 shows a perspective view of a wind turbine in accordance with a further embodiment of the present invention.

### DETAILED DESCRIPTION OF SPECIFIC EMBODIMENTS

Embodiments of the present invention generally relate to a blade for a wind turbine. The blade comprises an inner blade portion which is nearest an axis of rotation about which, in use, the blade rotates, and an outer blade s portion which is furthest from the axis of rotation. An angular orientation of the outer and inner blade portions relative to each other varies in a direction along the axis of rotation. The blade is twisted in a direction along the axis of rotation. In one example the axis of twist coincides with the axis of rotation.

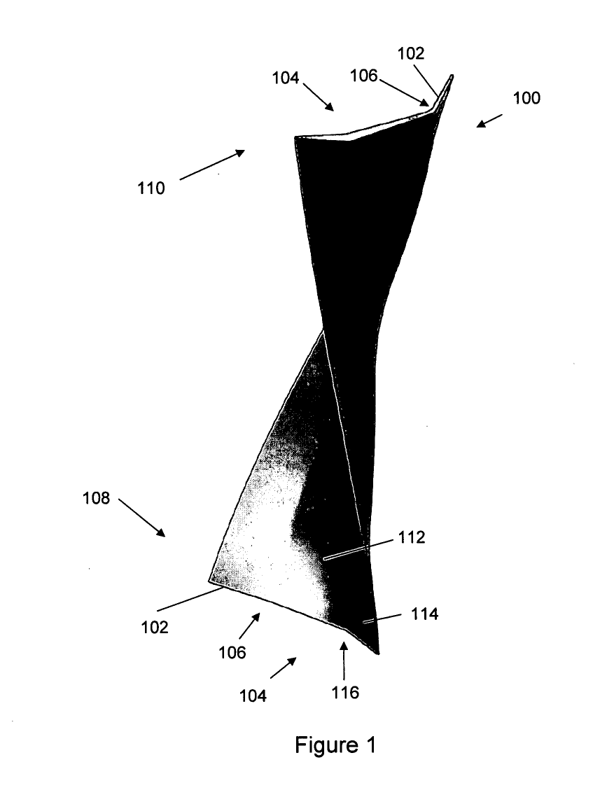

Referring initially to FIG. 1, there is shown a blade 100 comprising an outer blade portion 102 and an inner blade portion 104. An angle 106 between the outer and inner blade portions 102, 104 is shown to vary from a first end 108 to a second end 110 of the blade 100.

The inner portion 104 may further comprise first and second inner portions 112, 114 which are at an angle 116 to one another. The angle 116 is, in this example, substantially constant along the length of the blade 100.

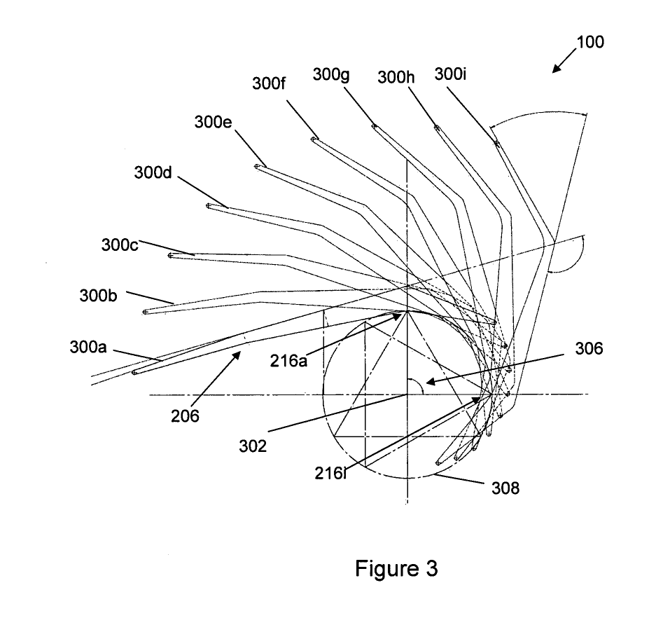

FIG. 1 also shows the blade 100 twisted in a helical fashion about an axis 302 (shown in FIG. 3) located outside the blade 100. In this example, the inner blade portion 104 is twisted through substantially 120°. It will be understood that the twist may be any suitable twist. For example, the inner blade portion 104 may be twisted by less than 120° for a 3 blade assembly, by 90° or less for a 4 blade assembly or by 180° or less for a 2 blade assembly. In this example the outer blade portion 102 has a twist that is smaller than that of the inner blade portion 104. It will be appreciated that other configurations are envisaged, for example configurations in which the outer blade portion 102 has a twist that is larger than the inner blade portion 104.

The blade 100 may have any suitable length and has in this example a length of approximately 5.5 m. Further, the blade 100 may have any suitable width and has in this example a width of approximately 1.8 m.

In this specific example the aspect ratio is 1.61:1, but alternatively may be any other suitable ratio.

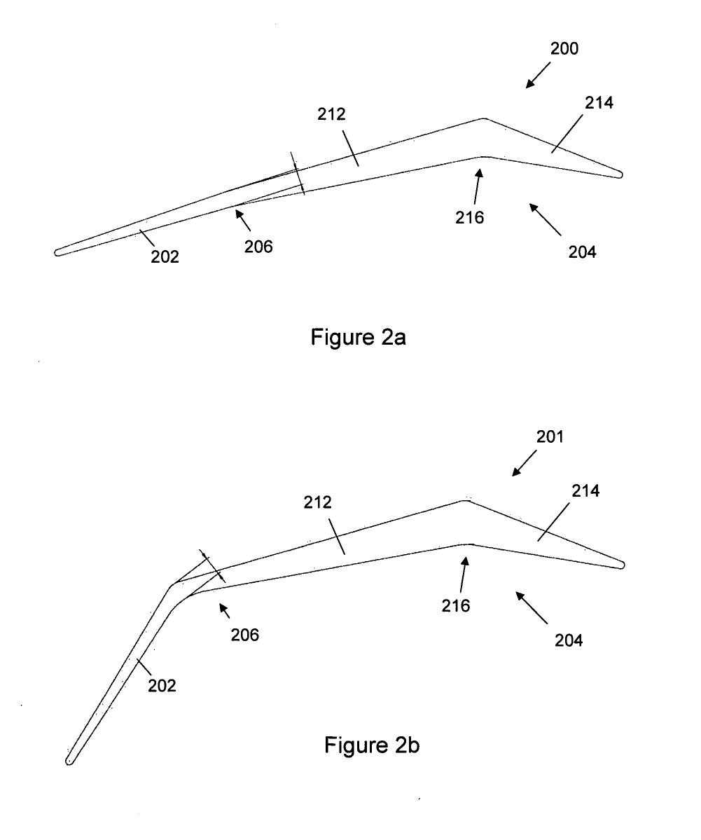

FIG. 2a shows a cross-sectional view 200 taken from the first end 108 of the blade 100. In this specific example, an angle of 206 between an outer blade portion 202 and an inner blade portion 204 is 177°. It will be appreciated, however, that the angle 206 between the outer and inner blade portions 202, 204 at the first end 108 of the blade 200 may in a variation be another appropriate angle. The angle 206 between the outer and inner blade portions 202, 204 may even be a substantially straight angle, such as an angle between 180° and 175° or another suitable angle.

FIG. 2b shows a cross-sectional view 201 taken from the second end 110 of the blade 100. In this example, the angle 206 between the outer and inner blade portions 202, 204 is 137°. It will be appreciated that the angle 206 between the outer and inner blade portions 202, 204 at the second end 110 of the blade 100 may in a variation be such as an angle between 135° and 140° or another suitable angle.

The twist of the blade 100 and a change of the angle 206 between the outer and inner blade portions 202, 204 are shown in FIG. 3, which shows a series of cross-sections 300a to 300i taken at uniform sections along the length of blade 100. In this example, cross-section 300a corresponds to the cross-section taken at the first end 108 of blade 100.

FIG. 3 shows blade 100 twisting around axis 302. The twist causes the blade 100 to move through an angle 304 of 120°. The twist also causes a region corresponding to the angle 216 between the first and second inner portions 212, 214 to transcribe an arc 306 of 90° of a circular path 308. It will be appreciated that this is only one example of a possible twist, and other twist angles and orientations are envisaged.

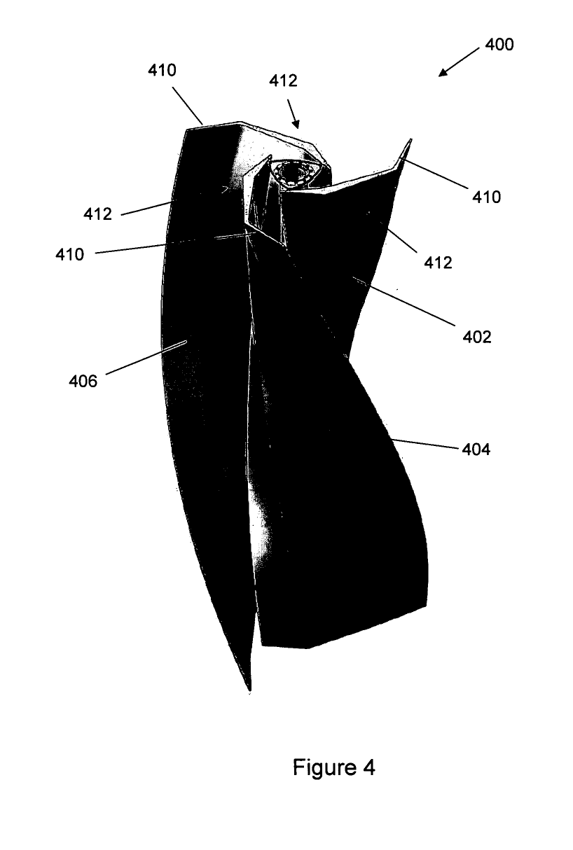

Referring now to FIG. 4 there is shown a wind turbine 400 comprising a plurality of blades 402, 404 and 406 mounted at 120° intervals around a shaft 408. An inner blade portion 412 of each blade 402, 404, 406 is mounted to the shaft 408 and an outer blade portion 410 is a free end. The wind turbine 400 also comprises a generator, which is not shown.

Although the invention has been described with reference to particular examples, it will be appreciated by those skilled in the art that the invention may be embodied in many other forms. For example, a blade or a plurality of blades may be used to form a water turbine. Further, a turbine comprising the blades may comprise any number of blades arranged in any suitable fashion. Similarly, it is envisaged that the amount of twist may be different for different configurations.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Reference that is being made to PCT international publication no. WO 03/058061 does not constitute an admission that that publication is part of the common general knowledge of a skilled person in Australia or any other country

1. A blade for a wind turbine, the wind turbine having an axis about which in use the blade rotates, the blade being arranged for orientation along the axis and having a longitudinal twist, the blade comprising an inner blade portion and an outer blade portion, the inner blade portion being in use closer to the axis than the outer blade portion, the inner blade portion and the outer blade portion having, in a plane perpendicular to the axis, an angular orientation relative to each other that varies for varying positions of the plane along the axis.

2. The blade of claim 1 wherein the blade is a blade for a vertical axis wind turbine.

3. The blade of claim 1 wherein at least a region of the inner blade portion is less twisted than the outer blade portion.

4. The blade of claim 1 wherein at least a region of the inner blade portion is more twisted than the outer blade portion.

5. The blade of claim 1 wherein the inner blade portion has a surface that has a substantially linear cross-sectional shape in a plane perpendicular to a direction of elongation of the blade.

6. The blade of claim 1 wherein the outer blade portion has a surface that has a substantially linear cross-sectional shape in a plane perpendicular to a direction of elongation of the blade.

7. The blade of claim 1 wherein the outer blade portion forms an obtuse angle with the inner blade portion at an area of contact between the inner blade portion and the outer blade portion.

8. The blade of claim 1 wherein the angular orientation of at least a portion of the inner blade portion relative to the outer blade portion changes in a linear manner along the length of the blade.

9. The blade of claim 1 wherein the longitudinal twist is such that the blade has a substantially helical configuration.

10. The blade of claim 1 wherein an axis of the longitudinal twist is outside the blade.

11. The blade of claim 10 wherein the axis of the longitudinal twist coincides with the axis of rotation.

12. The blade of claim 1 wherein at least a substantial portion of the blade is twisted through an angle of substantially 120° along the length of the blade.

13. The blade of claim 1 wherein the inner blade portion comprises first and second inner blade portions and wherein the blade is arranged such that the second inner blade portion is positioned between the first inner blade portion and the outer blade portion and wherein the second inner blade portion forms an obtuse angle with both the first inner blade portion and also the outer blade portion.

14. The blade of claim 13 wherein the first inner blade portion and the second inner blade portion have an angular orientation relative to each other that is substantially constant along the length of the blade.

15. The blade of claim 13 wherein the first inner blade portion and the second blade portion have an angular orientation relative to each other that changes along the length of the blade.

16. The blade of claim 1 being provided in the form of a substantially rectangular element that is twisted.

17. A blade assembly for a vertical axis wind turbine, the blade assembly comprising a plurality of blades, each of which being in accordance with claim 1.

18. The blade assembly of claim 17 comprising 3 blades and are arranged at substantially 120° around the axis of rotation.

19. A vertical axis wind turbine comprising the blade assembly of claim 17.
